(19) United States
(12) Patent Application Publication
(10) Pub. No.: US 2009/0204953 A1
(43) Pub. Date: Aug. 13, 2009

(54) Transforming data structures between different programming languages

(75) Inventors: Michael Alan Swingler, Palo Alto, CA (US); Scott Anthony Kovatch, Cupertino, CA (US); Thomas John O'Brien, San Jose, CA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/154,482

(22) Filed: May 23, 2008

Related U.S. Application Data
(60) Provisional application No. 61/065,408, filed on Feb. 11, 2008.

(51) Int. Cl. G06F 9/45

(52) U.S. Cl. 717/136

(57) ABSTRACT

Transforming data structures between different programming languages is disclosed. In some embodiments, a transformation module is configured to transform objects between a first programming language and a second programming language. In some embodiments, an object defined in a first programming language is received, and data comprising the object defined in the first programming language is copied and used to create a corresponding object defined in a second programming language.

### CROSS REFERENCE TO OTHER APPLICATIONS

This application claims priority to U.S. Provisional Patent Application No. 61/065,408, entitled CONVERTING OBJECTS, filed Feb. 11, 2008, which is incorporated herein by reference for all purposes.

### BACKGROUND OF THE INVENTION

Techniques for bridging data between different programming languages or systems exist. In some cases, limited functionality may exist for transforming basic data types (e.g., integer, float, double) defined in a first programming language to analogous types in a second programming language. Existing transformation techniques, however, do not provide functionality for transforming more complex or composite data structures from one programming language to corresponding data structures in another programming language. For example, a linked list object defined in a first programming language often has no direct transformation to a corresponding list data structure supported by a second programming language. Thus, an improved technique for transforming data structures between programming languages or systems is needed.

### BRIEF DESCRIPTION OF THE DRAWINGS

Various embodiments of the invention are disclosed in the following detailed description and the accompanying drawings.

FIG. 1A illustrates an embodiment of a processing environment for transforming objects from one object-oriented programming language to another.

FIG. 1B illustrates an embodiment of a system diagram.

FIG. 2A illustrates an embodiment of a transformation module.

FIG. 2B illustrates an example of a transformation module in which each transformation is specified as an explicit data or object type.

FIG. 3 illustrates an embodiment of a process for configuring a transformation module.

FIG. 4A illustrates an embodiment of a process for transforming an OOL1-based object to an OOL2-based object.

FIG. 4B illustrates an embodiment of a process for transforming an OOL2-based object to an OOL1-based object.

FIG. 5A illustrates an embodiment of a process for transforming an OOL1-based object into an OOL2-based object.

FIG. 5B illustrates an embodiment of a process for transforming an OOL2-based object into an OOL1-based object.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Enabling code that is based on a first object-oriented programming language to invoke directly functions, methods, and/or other code that is based on a second object-oriented programming language is disclosed. In some embodiments, an argument object with respect to which a function, method, or other operation based on the second object-oriented programming language is to be performed is transformed from the first object-oriented programming language to the second object-oriented programming language. For example, reflection may be employed to determine an object type of the second object-oriented programming language to which the object defined in the first object-oriented programming language should be transformed. An object of a first object-oriented programming language may need to be transformed to a corresponding object type of a second object-oriented programming language so that, for example, the transformed object can be processed with respect to code defined in the second object-oriented programming language, and any output objects resulting from executing the code defined in the second object-oriented programming language may be transformed into corresponding types of objects of the first object-oriented programming language. Such functionality may be useful, for example, when code defined in the first object-oriented programming language invokes and/or includes embedded code defined in the second object-oriented programming language. In some embodiments, during the transformation of an object of a first object-oriented programming language to a corresponding object type of a second object-oriented programming language, a copy of the object is made rather than creating a second in-memory reference. Although specific examples may be provided, the techniques described herein may be employed for the transformation of any object or data type from one programming language or system to another.

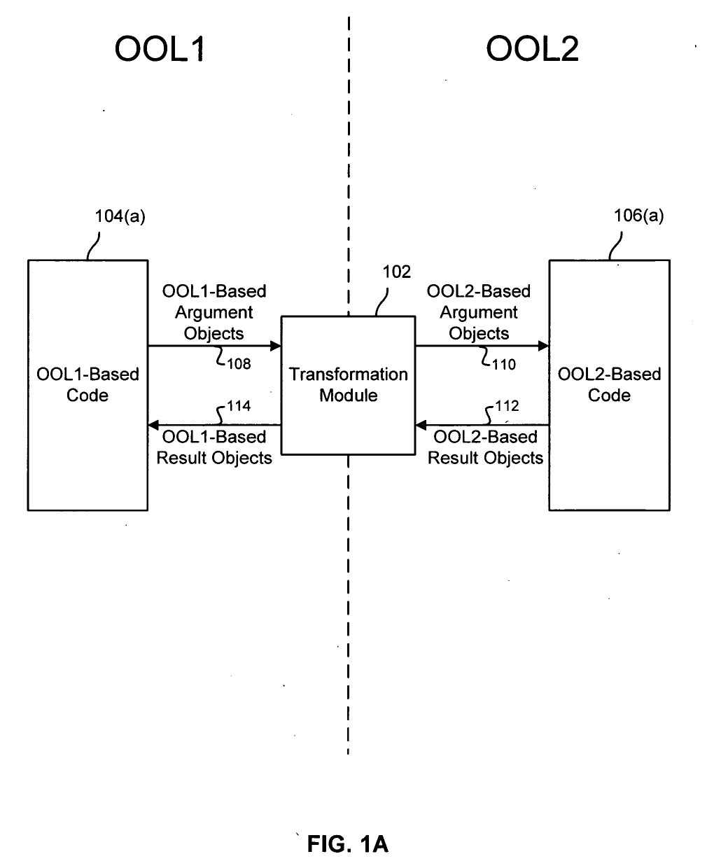

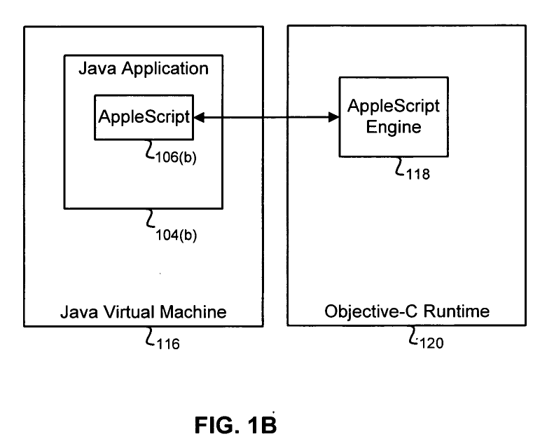

FIG. 1A illustrates an embodiment of a processing environment for transforming objects from one object-oriented programming language to another. As depicted, transformation module 102 facilitates the transformation of objects from object-oriented programming language 1 (OOL1) to-object-oriented programming language 2 (OOL2) and vice versa. In the given example, OOL1-based code 104(a) includes an invocation of OOL2-based code 106(a) (e.g., a call to an embedded OOL2 native function), with one or more OOL1-based objects passed as arguments. OOL1-based argument objects 108 are transformed by transformation module 102 into OOL2-based argument objects 110. OOL2-based code 106(a) is executed with respect to OOL2-based argument objects 110 and produces one or more OOL2-based result objects 112. OOL2-based result objects 112 are transformed by transformation module 102 into OOL1-based result objects 114, and execution of OOL1-based code 104(a) resumes with the statement following the invocation of OOL2-based code 106(a). In some embodiments, by employing the object transformation facilities of transformation module 102, OOL1-based code 104(a) is able to directly invoke non-native OOL2-based code using a native OOL2-based engine.

In one embodiment of FIG. 1A, for instance, OOL1-based code 104(a) may comprise a Java application running in a Java Virtual Machine, and OOL2-based code 106(a) may comprise Objective-C code. For example, a Java application 104(a) may include or encounter an embedded AppleScript 106(a). When AppleScript 106(a) is invoked by the Objective-C AppleScript Engine during the execution of Java application 104(a), Java application 104(a) may pass one or more Java objects as arguments to AppleScript 106(a). The Java objects 108 that are passed as arguments are transformed by transformation module 102 into corresponding Objective-C based objects 110. AppleScript 106(a) is executed with respect to objects 110 and outputs one or more result objects 112. The Objective-C based result objects 112 are transformed by transformation module 102 into corresponding Java-based result objects 114, and execution of Java application 104(a) resumes with the statement following the invocation of AppleScript 106(a). FIG. 1B illustrates an embodiment of a system diagram of the given example. As depicted, Java application 104(b) running in Java Virtual Machine 116 includes embedded AppleScript 106(b) which when invoked is executed using a native AppleScript engine 118 included in Objective-C runtime 120.

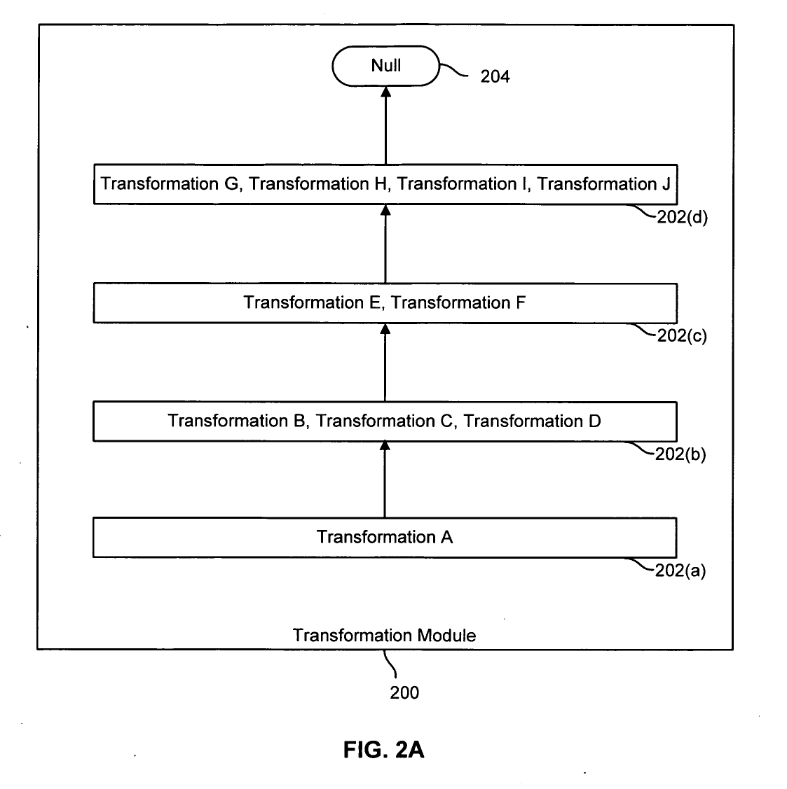

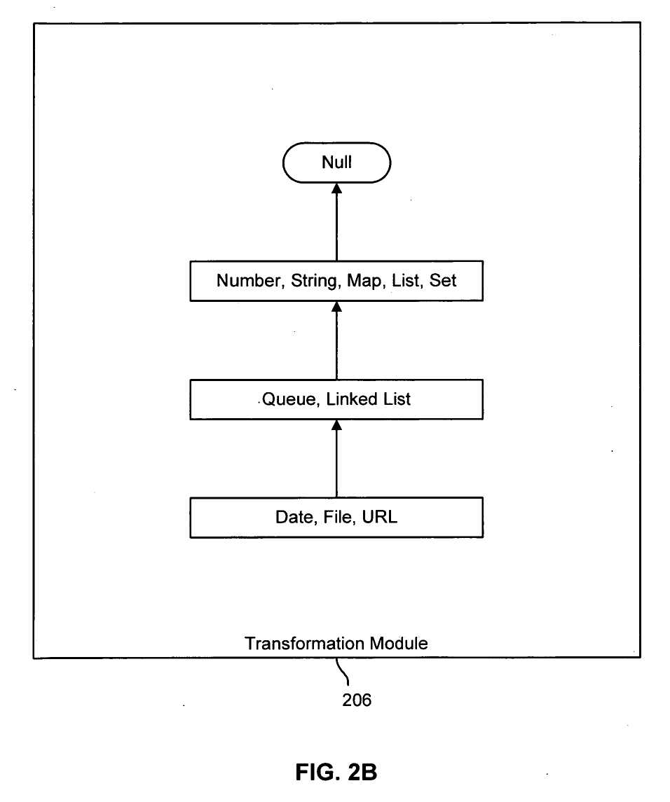

Multiple transformers may exist within one transformation module, and multiple transformations may exist within one transformer. The transformation module determines which transformer and transformation to use and can be configured to consider the transformers and transformations in a particular sequence as described further below. A manner in which to visualize the sequence is via a tree/hierarchy, such as shown in FIGS. 2A and 2B, where the tree/hierarchy is traversed from bottom to top and from left to right.

FIG. 2A illustrates an embodiment of a transformation module 200. In some embodiments, transformation module 200 comprises transformation module 102 of FIG. 1A. In some embodiments, transformation module 200 comprises a tree or hierarchy of one or more transformers 202. Each transformer 202 is an instance of a transformer class. Each transformer 202 includes one or more transformations. In some embodiments, a transformation as included in a transformer comprises an interface of a corresponding transformation object. In some embodiments, each transformation includes methods or functions for transforming objects of a prescribed type between different object-oriented language runtimes. For example, if transformation module 200 transforms between OOL1 and OOL2, each transformation includes a function for transforming an object of a type with which the transformation is associated from OOL1 to OOL2 and a function for transforming an object of that type from OOL2 to OOL1. In various embodiments, one or both of the above methods may be included and/or enabled in the case of any particular instance or use of a transformation. For example, at the option of a developer, a transformer and/or transformation may be configured to transform from OOL1 to OOL2, but not from OOL2 to OOL1.

In some embodiments, more generic or basic transformations are included in transformers higher up in the hierarchy, and more specific transformations (e.g., transformations associated with custom object types) are included lower in the hierarchy since the object transformation process traverses the hierarchy from bottom-up as described further below and as indicated in FIG. 2A by the upward arrows linking transformers 202. FIG. 2B illustrates an example of a transformation module 206 in which each transformation is specified as an explicit data or object type. In some embodiments, a transformation may itself be a transformer that is associated with one or more other transformations. For example, the Number transformation in the given example may itself be a transformer for one or more different Number data types, such as integer, float, double, etc. If transformation module 206 of FIG. 2B is associated with transforming between Java and Objective-C, for example, each transformation is associated with a method for transforming from Java to Objective-C and/or a method for transforming from Objective-C to Java.

As depicted in FIGS. 2A and 2B, the transformers of a transformation module may be linked or chained together. During an object transformation process, the hierarchy of transformers is traversed bottom-up (i.e. 202(a) to 202(d) in FIG. 2A) such that if a given transformer does not have the ability to transform the object, the task is delegated to its parent transformer. In some embodiments, during an object transformation process with respect to a given transformer, the transformations comprising the transformer are sequentially considered (e.g., for transformer 202(b) in FIG. 2A, Transformations B-D are sequentially considered). In some embodiments, the transformer hierarchy is traversed bottom-up, and the transformations within each transformer are traversed sequentially until the best transformation to transform an object in a first language to a corresponding object in a second language is found, if any such transformation exists in the hierarchy. With respect to FIG. 2A, for example, transformations are sequentially considered from Transformation A to Transformation J. In some embodiments, the top-most node 204 of the transformer hierarchy results in a null or invalid result being returned. In some such cases, for example, if the transformers and/or transformations in the hierarchy are not able to transform an object, appropriate exception handling is performed by node 204. In other embodiments, node 204 may comprise a transformer that includes a transformation for transforming the object to a string. In some such cases, for example, if none of the transformers and/or transformations below the default (top) level in the hierarchy are able to transform the object, the object is transformed at the default level into a string. In some embodiments, one side of a transformation may be specified as null. For example, a transformation may include a function for transforming from OOL1 to OOL2 and a function for transforming from OOL2 to null. In some such cases, a transformation from OOL2 to null may be skipped and a better or at least different transformation sought.

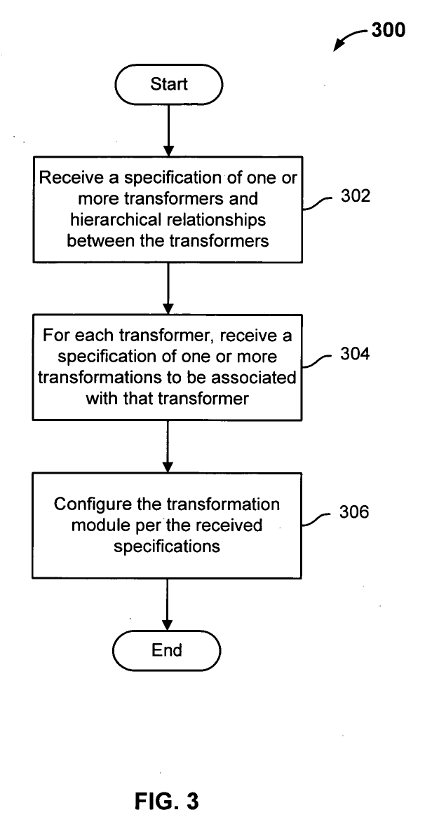

FIG. 3 illustrates an embodiment of a process for configuring a transformation module. For example, process 300 may be employed to configure transformation module 102 of FIG. 1A or transformation module 206 of FIG. 2B. In some embodiments, the transformers, transformer hierarchy, transformations, transformation sequences, and/or other configuration data are specified and/or defined by a programmer, such as a programmer associated with OOL1-based code 104(a) in FIG. 1A or an application developer of Java application 104(b) in FIG. 1B. Process 300 starts at 302 at which a specification of one or more transformers and hierarchical relationships between the transformers is received. In some embodiments, each transformer comprises an instance of a transformer class. For each transformer, a specification of one or more transformations to be associated with that transformer is received at 304. In some embodiments, each transformation comprises an instance of a transformation class associated with a particular object type. In some cases, the transformation functions of a transformation class associated with a particular object type are at least in part defined by the programmer and/or application developer. In some embodiments, 304 includes receiving applicable configuration data for each transformation. In some embodiments, a specification of a sequence in which to consider the transformations of each transformer is received at 304. In some embodiments, a sequence in which to consider the transformations of each transformer is inferred at 304 from an order in which the transformations are specified. The specifications received at 302 and 304 are employed to configure the transformation module at 306. Process 300 subsequently ends.

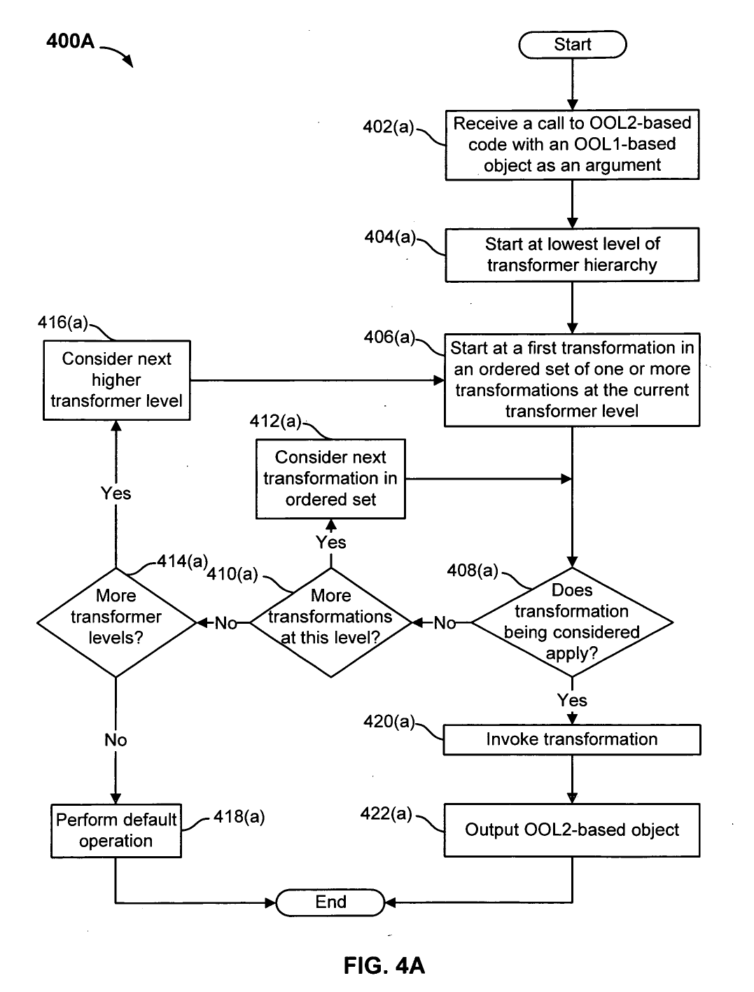

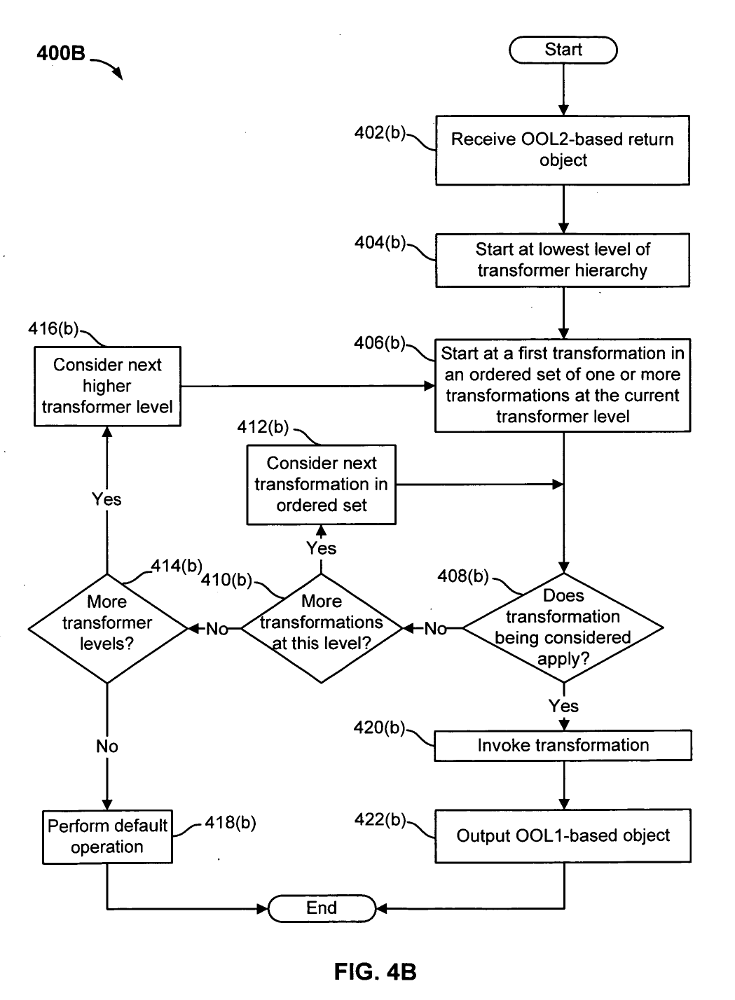

FIG. 4A illustrates an embodiment of a process for transforming an object in a first object-oriented programming language (OOL1) to an object in a second object-oriented programming language (OOL2). For example, process 400A may be invoked by transformation module 102 of FIG. 1A or transformation module 206 of FIG. 2B. In some embodiments, an explicit call to OOL2-based code in an OOL1-based program or application (e.g., in OOL1-based code 104(a) in FIG. 1A or Java application 104(b) in FIG. 1B) invokes process 400A.

Process 400A starts at 402(a) at which a call to OOL2-based code is received with an OOL1-based object as an argument. In some embodiments, the call comprises a call to an OOL2-based native function. Process 400A starts traversing the transformer hierarchy from its lowest or bottom-most transformer level at 404(a). Process 400A starts at a first transformation in an ordered set of one or more transformations at the current transformer level at 406(a). At 408(a), it is determined whether the transformation being considered applies to the OOL1-based object. If it is determined at 408(a) that the transformation being considered does not apply, it is determined at 410(a) whether any more transformations are associated with the current transformer level. If it is determined at 410(a) that more transformations are associated with the current transformer level, the next transformation in the ordered set is considered at 412(a), and process 400A continues at 408(a). If it is determined at 410(a) that no more transformations are associated with the current transformer level, it is determined at 414(a) whether more transformer levels exist. If it is determined at 414(a) that another transformer level exists, the next higher transformer level is considered at 416(a), and process 400A continues at 406(a). If it is determined at 414(a) that no more transformer levels exist, a default operation is performed at 418(a), and process 400A ends. In various embodiments, the default operation may comprise returning a “null” or “invalid” value, throwing an exception, transforming the object to a string, etc.

If it is determined at 408(a) that the transformation being considered applies, the transformation is invoked at 420(a) to transform the OOL1-based object to a corresponding OOL2-based object, the OOL2-based object is output at 422(a), and process 400A subsequently ends. In some embodiments, the (function) call of 402(a) includes multiple OOL1-based objects as arguments, and process 400A is iterated for each such OOL1-based object.

FIG. 4A illustrates a single iteration of process 400A to transform an OOL1-based object into an OOL2-based object. In some embodiments, a single OOL1-based object may comprise a collection or set of (nested) objects. In such cases, steps 404(a)-422(a) of process 400A may be iterated recursively for each object in the set until all objects in the set have been transformed. For example, the OOL1-based object may comprise a linked list, and each element of the linked list may comprise a map whose keys are strings and whose values are files. In such a case, steps 404(a)-422(a) are recursively iterated for the linked list, for each element (or map) of the linked list, for each key of each map, and for each value of each key. Each recursive iteration starts at step 404(a), with the root of the transformer hierarchy. Thus, the transformation of an object that comprises a set of objects results in the (automatic) transformation of the entire object graph associated with the object.

FIG. 4B illustrates an embodiment of a process for transforming an OOL2-based object to an OOL1-based object. For example, process 400B may be invoked by transformation module 102 of FIG. 1A or transformation module 206 of FIG. 2B.

Process 400B starts at 402(b) at which an OOL2-based return object is received. In some embodiments, the return object is received from executed OOL2-based code or an executed OOL2-based native function. Process 400B starts traversing the transformer hierarchy from its lowest or bottom-most transformer level at 404(b). Process 400B starts at a first transformation in an ordered set of one or more transformations at the current transformer level at 406(b). At 408(b), it is determined whether the transformation being considered applies to the OOL2-based object. If it is determined at 408(b) that the transformation being considered does not apply, it is determined at 410(b) whether any more transformations are associated with the current transformer level. If it is determined at 410(b) that more transformations are associated with the current transformer level, the next transformation in the ordered set is considered at 412(b), and process 400B continues at 408(b). If it is determined at 410(b) that no more transformations are associated with the current transformer level, it is determined at 414(b) whether more transformer levels exist. If it is determined at 414(b) that another transformer level exists, the next higher transformer level is considered at 416(b), and process 400B continues at 406(b). If it is determined at 414(b) that no more transformer levels exist, a default operation is performed at 418(b), and process 400B ends. In various embodiments, the default operation may comprise returning a “null” or “invalid” value, throwing an exception, transforming the object to a string, etc.

If it is determined at 408(b) that the transformation being considered applies, the transformation is invoked at 420(b) to transform the OOL2-based object to a corresponding OOL1-based object, the OOL1-based object is output at 422(b), and process 400B subsequently ends. In some embodiments, 402(b) includes receiving multiple OOL2-based return objects, and process 400B is iterated for each such OOL2-based object.

FIG. 4B illustrates a single iteration of process 400B to transform an OOL2-based object into an OOL1-based object. In some embodiments, a single OOL2-based object may comprise a collection or set of (nested) objects. In such cases, steps 404(b)-422(b) of process 400B may be iterated recursively for each object in the set until all objects in the set have been transformed. For example, the OOL2-based object may comprise a linked list, and each element of the linked list may comprise a map whose keys are strings and whose values are files. In such a case, steps 404(b)-422(b) are recursively iterated for the linked list, for each element (or map) of the linked list, for each key of each map, and for each value of each key. Each recursive iteration starts at step 404(b), with the root of the transformer hierarchy. Thus, the transformation of an object that comprises a set of objects results in the (automatic) transformation of the entire object graph associated with the object.

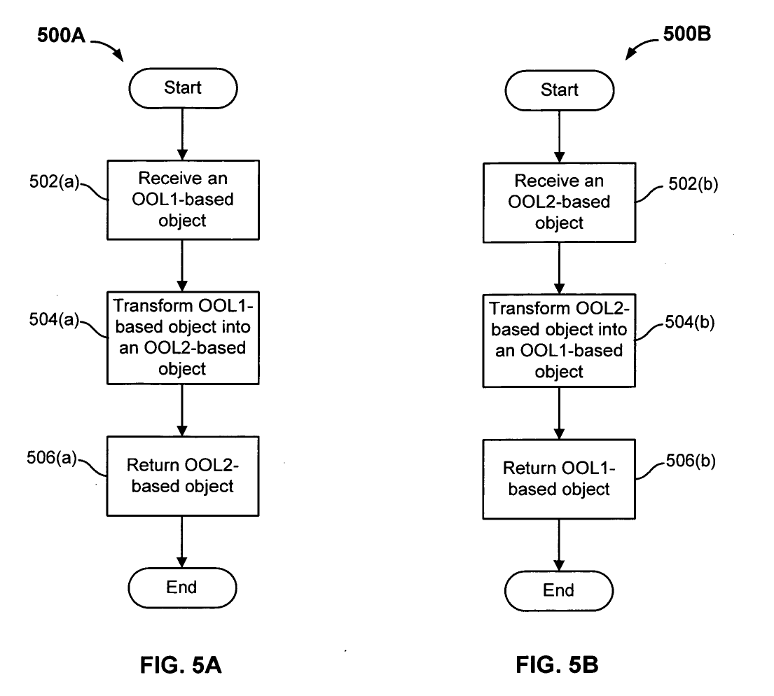

FIG. 5A illustrates an embodiment of a process for transforming an OOL1-based object into an OOL2-based object. For example, process 500A may be employed by a function associated with a transformation. In some embodiments, process 500A is employed at 420(a) of process 400A of FIG. 4A. Process 500A starts at 502(a) at which an OOL1-based object is received. At 504(a), the OOL1-based object is transformed into an OOL2-based object. In some embodiments, transforming the OOL1-based object to an OOL2-based object at 504(a) comprises copying the operative data bytes or payload or calling accessor functions of the object to obtain the necessary data of the OOL1-based object and using the copied bytes or obtained data to create a corresponding OOL2-based object. In some such cases, the OOL2-based object is managed in memory by an OOL2-based program, application, or engine. At 506(a), the OOL2-based object is returned, and process 500A ends.

FIG. 5B illustrates an embodiment of a process for transforming an OOL2-based based object into an OOL1-based object. For example, process 500B may be employed by a function associated with a transformation. In some embodiments, process 500B is employed at 420(b) of process 400B of FIG. 4B. Process 500B starts at 502(b) at which an OOL2-based object is received. At 504(b), the OOL2-based object is transformed into an OOL1-based object. In some embodiments, transforming the OOL2-based object to an OOL1-based object at 504(b) comprises copying the operative data bytes or payload or calling accessor functions of the object to obtain the necessary data of the OOL2-based object and using the copied bytes or obtained data to create a corresponding OOL1-based object. In some such cases, the OOL1-based object is managed in memory by an OOL1-based program, application, or engine. At 506(b), the OOL1-based object is returned, and process 500B ends.

Although some examples have been provided, the techniques described herein may be employed in any appropriate context for transforming an object or data type from one programming language or system to another. In various embodiments, the two object-oriented programming languages may be running in the same or different processes, operating systems, processors, and/or physical computers. In the cases in which one of the two languages is associated with a different process, operating system, processor, and/or computer, for example, the setter and getter accessor functions to transfer the payload of the data may be called through a remote procedure call (RPC) mechanism such as Unix RPC or XML-RPC. In some embodiments, the described techniques may also be employed to transform objects between a database or other non-object-oriented system that can emulate an object-oriented system through a series of constraints. An example of such constraints to emulate an object-oriented programming language would be a database table representing an object type, table columns representing the fields of the object, and foreign keys as references to other objects. In such cases, accessing and setting the data in the database language may be accomplished via a select or insert, e.g., as opposed to calling a setter or getter method.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for transforming an object, comprising:
receiving an object defined in a first programming language;
copying data comprising the object defined in the first programming language; and
using the copied data to create a corresponding object defined in a second programming language.

2. A method as recited in claim 1, wherein the object defined in the first programming language comprises an argument object passed to code defined in the second programming language being invoked from code defined in the first programming language.

3. A method as recited in claim 2, wherein the code defined in the second programming language is executed by a runtime associated with the second programming language.

4. A method as recited in claim 2, wherein execution of the code defined in the second programming language results in one or more result objects defined in the second programming language and further comprising using each of the one or more result objects defined in the second programming language to create a corresponding result object defined in the first programming language.

5. A method as recited in claim 2, wherein the code defined in the first programming language comprises a Java application executing in a Java Virtual Machine and wherein the code defined in the second programming language comprises an AppleScript embedded in the Java application and executed by an Objective-C runtime.

6. A method as recited in claim 1, further comprising performing a default operation if a corresponding object is not available in the second programming language.

7. A method as recited in claim 6, wherein the default operation comprises one or more of: returning a null or invalid value, throwing an exception, and transforming the object defined in the first programming language to a string object supported by the second programming language.

8. A method as recited in claim 1, wherein the object defined in the first programming language is part of a plurality of objects defined in the first programming language that is received and further comprising copying data comprising each of the objects defined in the first programming language included in the plurality and using the copied data to create a corresponding object defined in the second programming language.

9. A method as recited in claim 1, wherein copying data comprising the object defined in the first programming language comprises copying operative data or a payload associated with the object defined in the first programming language.

10. A method as recited in claim 1, wherein copying data comprising the object defined in the first programming language comprises calling one or more accessor functions of the object defined in the first programming language to obtain the data.

11. A method as recited in claim 1, wherein the object defined in the second programming language is managed in memory by one or more of a program, an application, and an engine associated with the second programming language.

12. A method as recited in claim 1, wherein transforming an object, including the object defined in the first programming language, is performed by a transformation module configured to transform objects between the first programming language and the second programming language.

13. A method as recited in claim 12, wherein the transformation module is at least in part specified by a programmer or developer of an application defined in the first programming language.

14. A method as recited in claim 12, wherein the transformation module comprises one or more transformers that are hierarchically linked.

15. A method as recited in claim 14, wherein each transformer comprises an ordered set of one or more transformations and wherein each transformation is associated with a particular type of object.

16. A method as recited in claim 15, further comprising traversing the transformers from lowest to highest in the hierarchy and traversing the transformations associated with each transformer in a prescribed order to locate, if available, an appropriate transformation for transforming the object defined in the first programming language to the corresponding object defined in the second programming language.

17. A method as recited in claim 15, wherein each transformation comprises one or both of: a function to transform the particular type of object with which the transformation is associated from the first programming language to the second programming language and a function to transform the particular type of object with which the transformation is associated from the second programming language to the first programming language.

18. A method as recited in claim 15, wherein a transformation comprises a transformer.

19. A method as recited in claim 1, wherein the object defined in the first programming language comprises a set of objects.

20. A method as recited in claim 19, further comprising using each object in the set of objects to create a corresponding object defined in the second programming language.

21. A method as recited in claim 1, wherein the first programming language comprises Java and the second programming language comprises Objective-C.

22. A method as recited in claim 1, wherein the first programming language comprises Objective-C and the second programming language comprises Java.

23. A method as recited in claim 1, further comprising determining an object type of the corresponding object in the second programming language by using reflection.

24. A system for transforming an object, comprising:
a processor configured to:
receive an object defined in a first programming language;
copy data comprising the object defined in the first programming language; and
use the copied data to create a corresponding object defined in a second programming language; and
a memory coupled to the processor and configured to provide the processor with instructions.

25. A system as recited in claim 24, wherein the object defined in the first programming language comprises an argument object passed to code defined in the second programming language being invoked from code defined in the first programming language.

26. A system as recited in claim 24, wherein the system comprises a transformation module configured to transform objects between the first programming language and the second programming language.

27. A computer program product for transforming an object, the computer program product being embodied in a computer readable storage medium and comprising computer instructions for:
receiving an object defined in a first programming language;
copying data comprising the object defined in the first programming language; and
using the copied data to create a corresponding object defined in a second programming language.

28. A computer program product as recited in claim 27, wherein the object defined in the first programming language comprises an argument object passed to code defined in the second programming language being invoked from code defined in the first programming language.

29. A computer program product as recited in claim 27, further comprising computer instructions for performing a default operation if a corresponding object is not available in the second programming language.

30. A computer program product as recited in claim 27, wherein transforming an object, including the object defined in the first programming language, is performed by a transformation module configured to transform objects between the first programming language and the second programming language.
